(19) United States
(12) Patent Application Publication
(10) Pub. No.: US 2019/0162445 A1
(43) Pub. Date: May 30, 2019

(54) EXTERIOR CASE FOR HOT WATER UNIT, HOT WATER UNIT AND METHOD OF MANUFACTURING EXTERIOR CASE FOR HOT WATER UNIT

(71) Applicant: NORITZ CORPORATION, Hyogo (JP)

(72) Inventors: Nobuhiro Fukui, HYOGO (JP); Hiroshi Fujii, HYOGO (JP)

(73) Assignee: NORITZ CORPORATION, HYOGO (JP)

(21) Appl. No.: 16/195,877

(22) Filed: Nov. 20, 2018

(30) Foreign Application Priority Data
Nov. 28, 2017 (JP) 2017-228101

(51) Int. Cl. F24H 9/02; F24H 9/00; B21D 11/10; B21D 5/00; B41M 5/00; B41M 7/00

(52) U.S. Cl. CPC F24H 9/02; F24H 9/0005; B21D 11/10; B41M 7/0081; B41M 5/0058; B41M 5/0088; B21D 5/00

(57) ABSTRACT

Provided is an exterior case for a hot water unit capable of displaying a manufacturer's logo and other desired letters, figures, and the like with satisfactory appearance at low cost. An exterior case for a hot water unit, which is formed by using metal sheet parts and is used to accommodate a hot water device for generating or storing hot water therein includes: a stepped pressed portion that is obtained by the metal sheet part being partially formed into a concave shape or a convex shape; and coated films that are provided on a bottom surface or a top surface and a side wall surface of the stepped pressed portion, and the coated films include an ink-jet printing layer provided at least on the bottom surface or the top surface of the stepped pressed portion, and the ink-jet printing layer represents at least any of letters, symbols, figures, and patterns.

### CROSS-REFERENCE TO RELATED APPLICATION

This application claims the priority benefit of Japan application serial no. 2017-228101, filed on Nov. 28, 2017. The entirety of the above-mentioned patent application is hereby incorporated by reference herein and made a part of this specification.

### BACKGROUND

### Technical Field

The disclosure relates to technologies related to a hot water unit with an exterior case that is caused to accommodate a hot water device for generating or storing hot water, such as a hot water dispenser or a cogeneration system.

### Description of Related Art

For a specific example of a hot water unit, there is a hot water device accommodated in an exterior case to heat hot water by utilizing fuel gas generated by a burner (see Patent Documents 1 to 3, for example). The exterior case is generally manufactured by performing press working on a colored steel sheet with a single-color surface.

Meanwhile, a manufacturer's logo, a model name, and the like of the hot water unit are displayed as means for identifying or distinguishing the hot water unit. In this case, it is desired to display the logo and the model name in a satisfactory appearance state.

Thus, means for producing an emblem indicating the logo and the model name and attaching this to the exterior case of the hot water unit has conventionally been used in many cases.

However, the emblem is expensive. Therefore, there is room for improvement in terms of facilitating reduction in costs for manufacturing a hot water device.

Note that although it is also possible to display a logo or the like by using painting means of a spraying scheme or a transfer scheme, for example, without using any emblem, decorative characteristics of the display of the logo or the like become insufficient, and it is difficult to achieve a satisfactory appearance merely by employing such means. In addition, painting operations in both the spraying scheme and the transfer scheme are complicated, and operability and producibility deteriorate therewith.

### Patent Documents

[Patent Document 1] Japanese Laid-Open No. 2012-32029

[Patent Document 2] Japanese Laid-Open No. 11-294867

[Patent Document 3] Japanese Laid-Open No. 2014-40950

[Patent Document 4] Japanese Laid-Open No. 6-247097

[Patent Document 5] Japanese Laid-Open No. 9-1049

### SUMMARY

The disclosure was conceived under the aforementioned circumstances, and an object thereof is to provides an exterior case for a hot water unit capable of displaying a manufacturer's logo, other desired letters or figures, and the like with satisfactory appearance at low cost, a hot water unit provided with the exterior case, and a method of manufacturing the exterior case for a hot water unit.

An exterior case for a hot water unit that is provided according to an embodiment of the disclosure is an exterior case, which is formed by using metal sheet parts and is used to accommodate a hot water device for generating or storing hot water therein, the exterior case including: a stepped pressed portion that is obtained by one of the metal sheet parts being partially formed into a concave shape or a convex shape; and coated films that are provided on a bottom surface or a top surface and a side wall surface of the stepped pressed portion, in which the coated films include an ink-jet printing layer provided at least on the bottom surface or the top surface of the stepped pressed portion, and the ink-jet printing layer represents at least any of letters, symbols, figures, and patterns.

A hot water unit that according to an embodiment of the disclosure includes: the exterior case for a hot water unit that is provided above.

A method of manufacturing an exterior case for a hot water unit that is provided according to an embodiment of the disclosure is a method of manufacturing an exterior case for a hot water unit, which is formed by using metal sheet parts and is used to accommodate a hot water device for generating or storing hot water therein, the method including: a painting process in which coated films including an ink-jet printing layer that represents at least any of letters, symbols, figures, and patterns are provided by performing ink-jet printing on outer surfaces of a substantially flat sheet-shaped metal sheet that is a base material of the metal sheet parts; and a pressing process in which a location in which the ink-jet printing layer is provided or the location and a surrounding portion thereof in the metal sheet are formed into a partially concave or convex stepped pressed portion, after the painting process.

### BRIEF DESCRIPTION OF THE DRAWINGS

FIG. 1(a) is a side view illustrating an example of a hot water unit according to the disclosure, and FIG. 1(b) is an exploded perspective view of an exterior case of the hot water unit illustrated in FIG. 1(a) (a state in which a hot water device provided inside is omitted).

FIG. 2(a) is a front view of main parts of a cover body of the exterior case illustrated in FIG. 1, and FIG. 2(b) is a sectional view along IIb-IIb in FIG. 1(a).

FIGS. 3(a) to 3(c) are outline perspective views illustrating an example of a method of manufacturing the cover body of the exterior case illustrated in FIG. 1.

FIG. 4(a) is a perspective view illustrating an example of an outline configuration of a printer used for ink-jet printing, and FIG. 4(b) is diagram viewed along the arrow IVb in FIG. 4(a) and is a diagram illustrating an outline structure of a print head in the printer illustrated in FIG. 4(a).

FIG. 5(a) is a front view of main parts illustrating another example of the disclosure, and FIG. 5(b) is a sectional view along Vb-Vb in FIG. 5(a).

FIG. 6(a) is a front view of main parts illustrating another example of the disclosure, and FIG. 6(b) is a sectional view along VIb-VIb in FIG. 6(a).

FIG. 7(a) is a front view of main parts illustrating another example of the disclosure, and FIG. 7(b) is a sectional view along VIIb-VIIb IN FIG. 7(a).

FIG. 8 is a sectional view of main parts illustrating another example of the disclosure.

FIGS. 9(a) to 9(d) are sectional views of main parts illustrating another example of the disclosure.

### DESCRIPTION OF THE EMBODIMENTS

An exterior case for a hot water unit that is provided according to an embodiment of the disclosure is an exterior case, which is formed by using metal sheet parts and is used to accommodate a hot water device for generating or storing hot water therein, the exterior case including: a stepped pressed portion that is obtained by one of the metal sheet parts being partially formed into a concave shape or a convex shape; and coated films that are provided on a bottom surface or a top surface and a side wall surface of the stepped pressed portion, in which the coated films include an ink-jet printing layer provided at least on the bottom surface or the top surface of the stepped pressed portion, and the ink-jet printing layer represents at least any of letters, symbols, figures, and patterns.

Here, the ink-jet printing layer is a printing layer that is formed by spraying minute ink droplets onto a region to be painted utilizing an ink-jet printer.

According to such a configuration, the following is obtained.

First, although the desired letters, symbols, figures, or patterns (hereinafter, appropriately abbreviated as “letters and the like”) are represented using the ink-jet printing layer of the exterior case, these letters and the like are not limited to ones simply displayed in a planar region of the exterior case and may be displayed on a bottom surface of a concave stepped pressed portion or a top surface of a convex stepped pressed portion. Further, since the coated film is also provided on the side wall surface of the stepped pressed portion, this portion can be in a form such as a frame that surroundings the letters and the like in a three-dimensional manner. Therefore, it is possible to cause the entire stepped pressed portion in which the letters and the like are displayed to have decorative characteristics and thus a satisfactory appearance. As a result, it is possible to eliminate a necessity to use an expensive emblem and to appropriately reduce manufacturing costs.

Second, the ink-jet printing layer can be simply provided by using an ink-jet printer, a painting operation is more easily performed, and more satisfactory operability is achieved as compared with painting means of a spray scheme or a transfer scheme, for example. Also, hardly any ink paint is wasted. Therefore, it is possible to further reduce manufacturing costs.

Third, according to the ink-jet printing layer, it is possible to express fine patterns with complicated shapes, patterns in which many color hues are used, and the like, which is further preferable in terms of an improvement in an appearance form of the hot water unit. Also, it is also possible to bring an operation environment into a more satisfactory state as compared with the painting means of a spray scheme, for example.

According to an embodiment of the disclosure, the exterior case for a hot water unit further includes: as the metal sheet parts, an exterior case main body with at least one surface formed as an opening portion; and a cover body that is attached to the exterior case main body such that the cover body blocks the opening portion and that the coated films including the stepped pressed portion and the ink-jet printing layer be provided on at least one of the exterior case main body and the cover body.

According to an embodiment of the disclosure, the bottom surface or the top surface and the side wall surface of the stepped pressed portion has coated films with different color hues.

With such a configuration, it is possible to further enhance decorative characteristics of the stepped pressed portion.

According to an embodiment of the disclosure, the coated films on the bottom surface or the top surface of the stepped pressed portion have a color hue that is different from a color hue of an outer surface of a circumferential portion of the stepped pressed portion.

With such a configuration, it is possible to make the entire stepped pressed portion appear distinctive and to further enhance decorative characteristics thereof

According to an embodiment of the disclosure, the exterior case for a hot water unit further includes: a transparent paint layer that covers the ink-jet printing layer.

With such a configuration, it is possible to cause the letters and the like represented using the ink-jet printing layer to appear in a glossy state, which is more preferable in terms of an improvement in decorative characteristics.

According to an embodiment of the disclosure, as the stepped pressed portion, a stepped portion that represents letters, symbols, figures, or patterns in a three-dimensional manner is provided.

With such a configuration, superior decorative characteristics are achieved since letters and the like are represented in a three-dimensional manner.

A hot water unit that according to an embodiment of the disclosure includes: the exterior case for a hot water unit that is provided above.

With such a configuration, effects that are similar to those described above in relation to the exterior case for a hot water unit that is provided above are obtained.

A method of manufacturing an exterior case for a hot water unit that is provided according to an embodiment of the disclosure is a method of manufacturing an exterior case for a hot water unit, which is formed by using metal sheet parts and is used to accommodate a hot water device for generating or storing hot water therein, the method including: a painting process in which coated films including an ink-jet printing layer that represents at least any of letters, symbols, figures, and patterns are provided by performing ink-jet printing on outer surfaces of a substantially flat sheet-shaped metal sheet that is a base material of the metal sheet parts; and a pressing process in which a location in which the ink-jet printing layer is provided or the location and a surrounding portion thereof in the metal sheet are formed into a partially concave or convex stepped pressed portion, after the painting process.

With such a configuration, it is possible to appropriately manufacture the exterior case for a hot water unit provided by the first aspect of the disclosure.

Other features and advantages of the disclosure will become more obvious from the description of an embodiment of the disclosure given below with reference to accompanying drawings.

Hereinafter, an exemplary embodiment of the disclosure will be specifically described with reference to drawings.

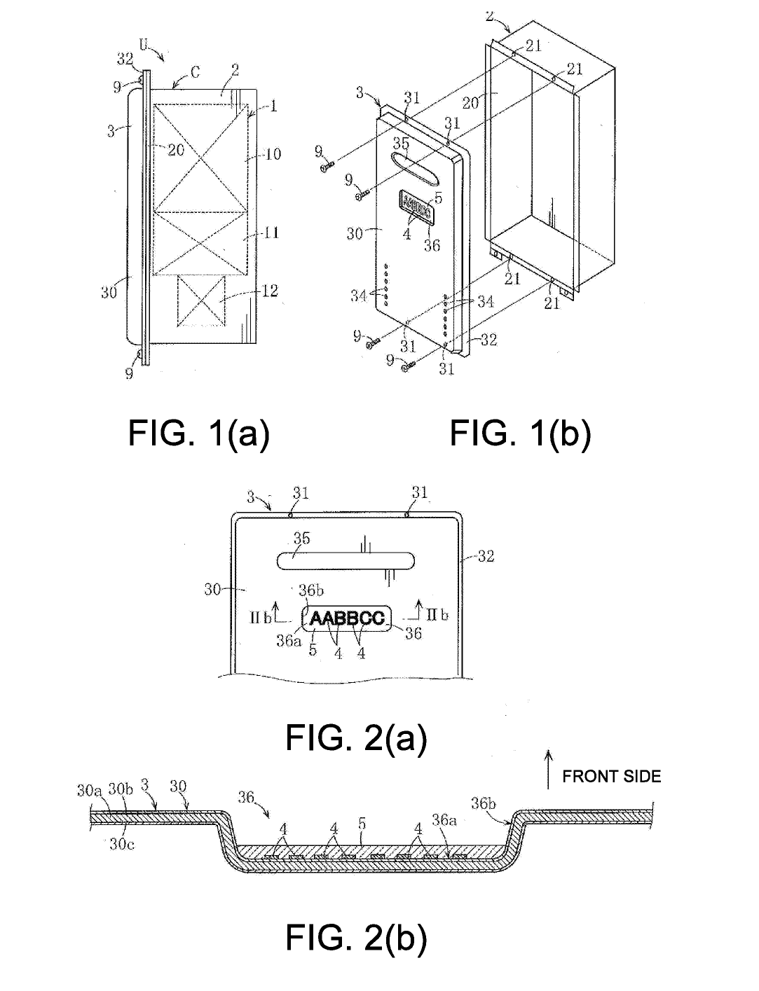

A hot water unit U illustrated in FIGS. 1(a) and 1(b) is a hot water dispenser and has a configuration in which a hot water device 1 for generating hot water is accommodated in an exterior case C. The hot water device 1 includes a heat exchanger 10 through which hot water is distributed, a burner 11 that is for heating hot water in the heat exchanger 10, and a fan 12 that supplies combustion air to the burner 11.

The exterior case C includes an exterior case main body 2 with a rectangular box shape that has an opening portion in a front surface and a cover body 3 (front cover body) that blocks the opening portion 20. The cover body 3 is detachably attached to a front surface portion of the exterior case main body 2 by utilizing a screw body 9 such as a screw, for example, and screw insertion holes 31 and 21 into which the screw body 9 is inserted.

The exterior case main body 2 and the cover body 3 correspond to metal sheet parts in the disclosure. In the embodiment, a stepped pressed portion 36 and an ink jet printing layer 4 are provided on the cover body 3 while the exterior case main body 2 is not provided with them. Therefore, a configuration of the cover body 3 will be mainly described below, and description of the exterior case main body 2 will be omitted. However, it is a matter of course that the stepped pressed portion and the ink-jet printing layer may be provided in the exterior case main body 2 as will be described later.

The cover body 3 is formed by performing press working on a colored steel sheet 30, which will be described later, and has a substantially rectangular panel shape in a front view. The cover body 3 includes an outer circumferential flange portion 32 that is caused to face the front surface portion of the exterior case main body 2 and is brought into contact with the front surface portion, an air supply port 34 that enables flowing of external air into the exterior case C, and an air exhaust port 35 that is for discharging exhaust gas after heat collection performed by the heat exchanger 10 to the outside of the exterior case C.

The stepped pressed portion 36 and the ink-jet printing layer 4 are provided on the cover body 3 as described above. As clearly shown in FIGS. 2(a) and 2(b), the stepped pressed portion 36 is a site at which a part of a front surface (outer surface) of the cover body 3 is formed into a partially concave portion recessed on a rear surface side of the cover body 3 and has a substantially rectangular shape in a front view, for example, or an oval shape or the like. The ink-jet printing layer 4 represents letters, for example, a manufacturer's logo of the hot water unit U and is provided on the bottom surface 36a of the stepped pressed portion 36. Although the letters represented using the ink-jet printing layer 4 are “AABBCC” in the drawing for convenience, the letters are not limited thereto. The ink-jet printing layer 4 is a coated film that is provided by using an ink-jet printer 8 as will be described later. Although a water-based pigment ink or solvent-based pigment ink can be used for an ink for the ink-jet printing, an ink containing an ultraviolet curable resin or a thermosetting resin is used in the embodiment.

The colored steel sheet 30 is used as a metal sheet that is a base material for the cover body 3 as described above, and the colored steel sheet 30 has a multilayered structure that has a coated steel sheet 30a, a paint layer 30b on the front side, which is laminated on the surface of the coated steel sheet 30a, and a paint layer 30c on the rear side, which serves as a service coating laminated on the rear surface of the coated steel sheet 30a, as illustrated in FIG. 2(b). In addition to the ink-jet printing layer 4, paint layers 30b and 30c of the colored steel sheet 30 are also included in the concept of the “coated film” described in the disclosure. A circumferential portion of the stepped pressed portion 36 and a top layer portion of the side wall surface 36b of the stepped pressed portion 36 in the front surface of the cover body 3 have the paint layer 30b formed thereon. The ink-jet printing layer 4 has a color hue that is different from that of the paint layer 30b and is provided on the paint layer 30b in a laminated manner.

A transparent paint layer 5 that covers the ink-jet printing layer 4 is further provided inside the stepped pressed portion 36. This transparent paint layer 5 may be either colorless and transparent or colored and transparent.

The cover body 3 can be manufactured by the following processes.

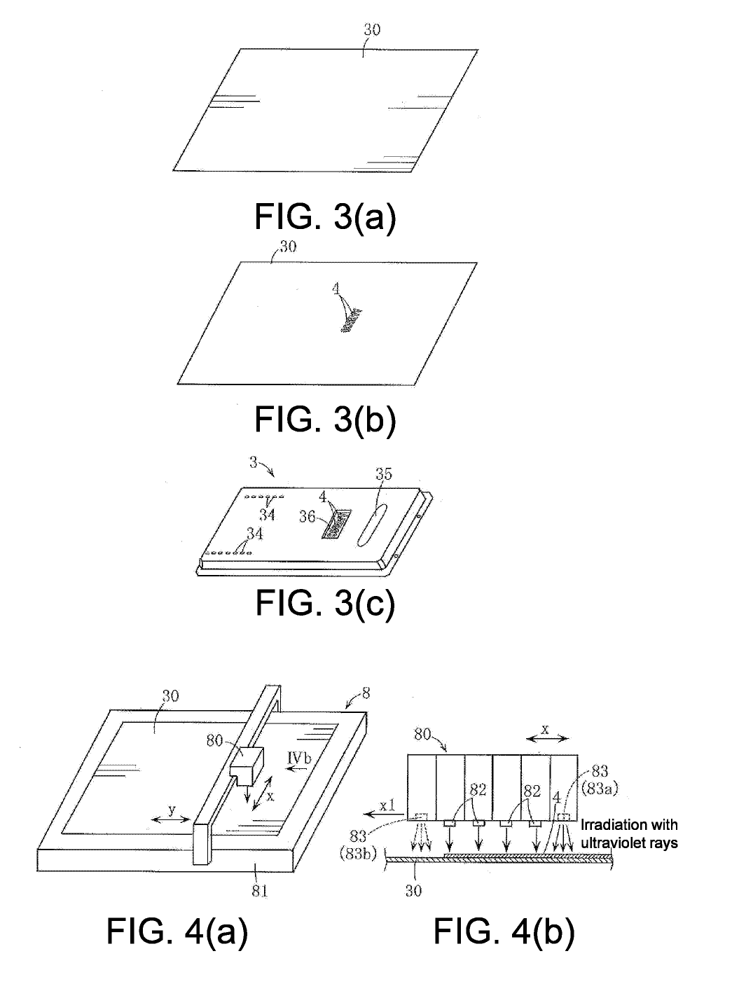

First, a flat sheet-shaped colored steel sheet 30 is prepared as a base material of the cover body 3 as illustrated in FIG. 3(a). Then, ink-jet printing is performed on the colored steel sheet 30 (in a strict sense, on the paint layer 30b of the colored steel sheet 30), and the ink-jet printing layer 4 is provided as illustrated in (b) in the same drawing. The ink-jet printing is performed by using the ink jet printer 8 as illustrated in FIG. 4(a), for example. The ink jet printer 8 is adapted such that a print head 80 freely moves in x and y directions that orthogonally intersect one another above a platform 81 on which the colored steel sheet 30 is placed and supported. The print head 80 includes a plurality of ink-jet nozzles 82 that spray minute ink jet paint droplets with a predetermined color toward the colored steel sheet 30 as illustrated in FIG. 4(b) and is similar to a conventionally known one in this regard. However, a pair of ultraviolet light sources 83 (83a, 83b) are further provided in the embodiment.

When ink-jet printing is performed while the print head 80 is caused to move in an x1 direction in the drawing, which is a main scanning direction, for example, the ultraviolet light source 83a on the rear side in the main scanning direction is caused to emit light and is caused to irradiate a region immediately after the ink-jet printing is performed with ultraviolet radiation. Since the ink-jet printing layer 4 contains an ultraviolet curable resin, it is possible for the ink-jet printing layer 4 to cure quickly (cure to such an extent that no bleeding, which will be described later, occurs) due to the aforementioned irradiation with ultraviolet radiation. Therefore, it is possible to prevent defects such as occurrence of bleeding due to mixing of the ink-jet printing layer 4 with different color hues in an uncured state. When the ink-jet printing is advanced in a direction opposite to the aforementioned x1 direction, effects similar to those described above are obtained by causing the ultraviolet light source 83b to emit light instead of the ultraviolet light source 83a. Although the transparent paint layer 5 may also be provided using ink-jet printing, the transparent paint layer 5 may be provided using spray coating or the like after the stepped pressed portion 36 is formed in a subsequent process.

After the aforementioned ink-jet printing on the colored steel sheet 30 is finished, the colored steel sheet 30 is heated, the ink-jet printing layer 4 is dried, and the thermosetting resin contained in the ink-jet printing layer 4 is cured. The heating is performed by utilizing a heating furnace, for example. It is possible to enhance a strength of the ink-jet printing layer 4 and to achieve excellent weather resistance and the like through such processing.

Thereafter, press working is performed on the aforementioned colored steel sheet 30 to form the cover body 3 as illustrated in FIG. 3(c). Regarding the aforementioned press working, stepped press working to provide the stepped pressed portion 36 is also performed in addition to squeeze processing for imparting a bulge to the colored steel sheet 30, working to form the air supply port 34 and the air exhaust port 35, and the like. The stepped press working is working to form a recess at a location at which the ink-jet printing layer 4 is provided and a circumferential portion thereof in the colored steel sheet 30 on the rear surface side of the colored steel sheet 30.

If the stepped pressed portion 36 is formed by performing press working for the colored steel sheet 30 before the ink-jet printing is performed, for example, unlike the aforementioned series of processes, it is difficult to perform ink-jet printing on the bottom surface 36a of the stepped pressed portion 36 thereafter. Meanwhile, it is possible to appropriately avoid such defects through the aforementioned series of processes.

Next, effects of the aforementioned exterior case C and the hot water unit U will be described.

First, the ink-jet printing layer 4 provided on the front surface of the cover body 3 represents a manufacturer's logo or the like of the hot water unit U, and the ink-jet printing layer 4 attracts attention and becomes decorative since the ink-jet printing layer 4 is provided on the bottom surface 36a of the concave stepped pressed portion 36 and is positioned at a location with a step difference from the other regions in the front surface of the cover body 3. Also, since the paint layer 30b is present in the region in which the ink-jet printing layer 4 is not provided on the bottom surface 36a of the stepped pressed portion 36 and the side wall surface 36b, the stepped pressed portion 36 itself does not appear as a concave portion with a poor appearance. The transparent paint layer 5 imparts glossiness to the region in which the ink-jet printing layer 4 is provided.

In this manner it is possible to give satisfactory design characteristics and a satisfactory appearance to the manufacturer's logo or the like represented using the ink-jet printing layer 4. Therefore, it becomes unnecessary to use an expensive emblem, for example, as means for displaying a logo or the like. As a result, it is possible to reduce manufacturing costs of the exterior case C and thus manufacturing costs of the hot water unit U.

Meanwhile, the ink-jet printing layer 4 can be simply provided by using the ink-jet printer 8 as described above, masking processing, color adjustment of the paint, and the like are not necessary, and skills are not required, unlike spray scheme painting, for example. Therefore, it is possible to achieve satisfactory operability and producibility and to further reduce manufacturing costs. In addition, designs which can be represented using the ink-jet printing layer 4 may be changed easily, which is suitable for production of small amounts of products of various types. Further, hardly any of the ink paint is wasted, and the environmental burden is also low with ink-jet printing.

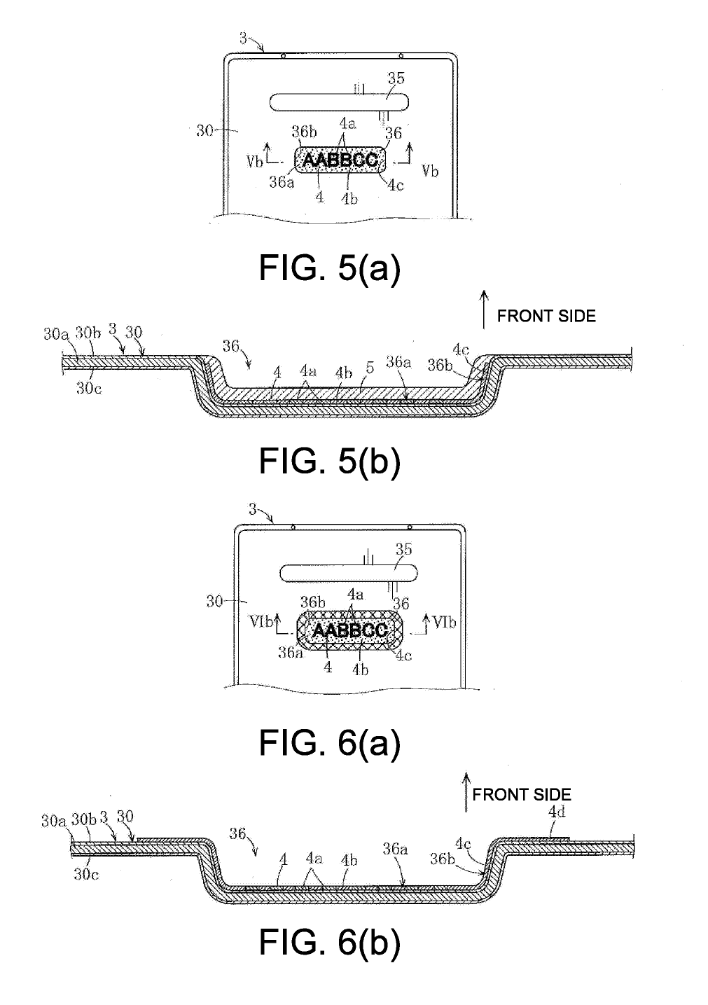

FIGS. 5(a) to 9(d) illustrate other embodiments of the disclosure. In these drawings, the same reference numerals as those in the aforementioned embodiment are given to elements that are the same as or similar to those in the aforementioned embodiment, and duplicated description thereof is omitted.

In the embodiment illustrated in FIGS. 5(a) and 5(b), the ink-jet printing layer 4 is provided to extend across both the bottom surface 36a and the side wall surface 36b of the stepped pressed portion 36 of the cover body 3. The ink-jet printing layer 4 has a region 4a that is provided on the bottom surface 36a and represents letters such as a manufacturer's logo, a region 4b that is provided on the bottom surface 36a and represents a background for the letters (the dotted portion in the drawing), and a region 4c that is provided on the side wall surface 36b. The region 4c has a color hue that is different from those of the region 4a and of the paint layer 30b of the colored steel sheet 30.

According to the embodiment, the region 4c of the ink-jet printing layer 4 appears in a frame shape that surrounds the entire regions 4a and 4b. Therefore, it is possible to further enhance design characteristics near the display location of the manufacturer's logo or the like.

In the embodiment illustrated in FIGS. 6(a) and 6(b), the ink-jet printing layer 4 has a region 4d (cross-hatched portion) that is provided in the surroundings of the stepped pressed portion 36 in addition to the regions 4a to 4c provided on the bottom surface 36a and the side wall surface 36b of the stepped pressed portion 36 of the cover body 3. The region 4d has a frame shape surrounding the stepped pressed portion 36 and has a color hue that is different from those of the region 4c and of the paint layer 30b of the colored steel sheet 30.

It is possible to further enhance design characteristics near the display location of the manufacturer's logo or the like also in this embodiment.

Note that although illustration thereof in the drawing is omitted in the embodiment, a configuration in which the transparent paint layer 5 is further provided can also be employed. The same is true for the other embodiments which will be described below.

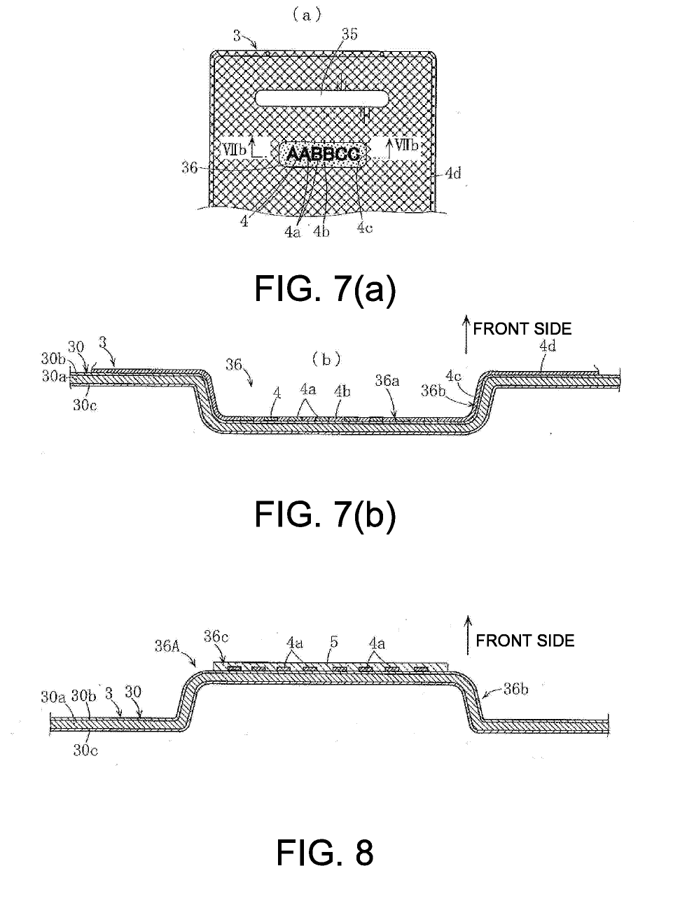

In the embodiment illustrated in FIGS. 7(a) and 7(b), the ink-jet printing layer 4 has the region 4d (cross-hatched portion) provided in a wide area that includes the surroundings of the stepped pressed portion 36 and a region other than the surroundings. The region 4d may be provided over substantially the entire front surface of the cover body 3, for example.

According to the embodiment, it is possible to present a variety of patterns in the region 4d of the ink jet printing layer 4, which is preferable for enhancing design characteristics of the entire exterior case C.

As can be understood from the embodiment, it is possible to employ a configuration in which the ink-jet printing layer is provided over a wide area other than the stepped pressed portion in the disclosure.

In the embodiment illustrated in FIG. 8, the stepped pressed portion 36A has a convex form in which the front surface of the cover body 3 projects forward, and the ink-jet printing layer 4a and the transparent paint layer 5 that covers the ink-jet printing layer 4a are provided on the top surface 36c.

It is possible to cause the manufacturer's logo or the like represented using the ink-jet printing layer 4a to appear distinctive and to eliminate a necessity of using an emblem even in the embodiment.

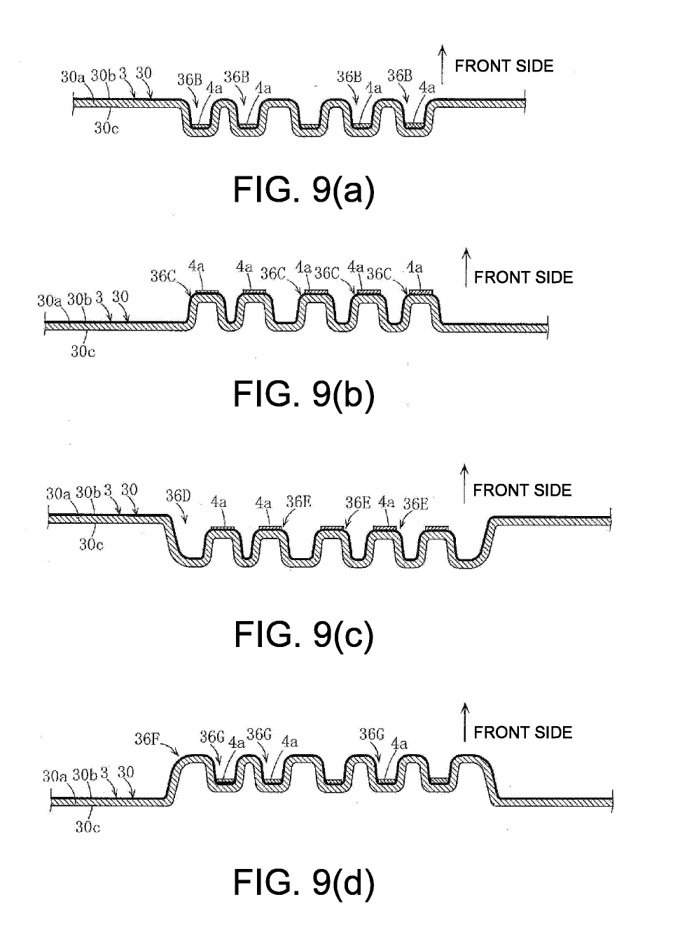

Although illustration is omitted in FIG. 8, it is also possible to provide the ink-jet printing layer on the side wall surface 36b of the stepped pressed portion 36A or at a location other than the stepped pressed portion 36A. The same is true for the other embodiment which will be described with reference to FIGS. 9(a) to 9(d).

In the embodiment illustrated in FIG. 9(a), a plurality of concave stepped pressed portions 36B are provided in the front surface of the cover body 3. The plurality of stepped pressed portions 36B have a form representing a manufacturer's logo or the like in a front view and form so-called three-dimensionally concave letters. The ink-jet printing layers 4a are provided on bottom surfaces of the respective stepped pressed portions 36B.

In the embodiment illustrated in FIG. 9(b), a plurality of convex stepped pressed portions 36C are provided in the front surface of the cover body 3 in a manner opposite to that in FIG. 9(a), and the stepped pressed portions 36C form so-called three-dimensionally convex letters. The ink-jet printing layers 4a are provided on top surfaces of the respective stepped pressed portions 36C.

As can be understood from these embodiments, the plurality of stepped pressed portions described in the disclosure may be provided, or the stepped pressed portions can be formed as three-dimensional letters or the like.

In the embodiment illustrated in FIG. 9(c), a predetermined region in the front surface of the cover body 3 is formed into a concave stepped pressed portion 36D, and a plurality of additional convex stepped pressed portions 36E are provided on a bottom portion of the stepped pressed portion 36D. The additional stepped pressed portions 36E are formed into so-called three-dimensionally convex letters, and the ink-jet printing layer 4a is provided on the top surface thereof.

In the embodiment illustrated in FIG. 9(d), a predetermined region in the front surface of the cover body 3 is formed into a convex stepped pressed portion 36F in a manner opposite to that in FIG. 9(c), and a plurality of additional concave stepped pressed portions 36G are provided at the top portion of the stepped pressed portion 36F. The additional stepped pressed portions 36G are formed into so-called three-dimensionally concave letters, and the ink jet printing layer 4a is provided on the bottom surface thereof.

As can be understood from these embodiments, the stepped pressed portion described in the disclosure can be a double-stepped pressed portion obtained by further step-pressing a part of the stepped pressed portion.

The disclosure is not limited to the content of the aforementioned embodiments. The designs of the specific configurations of the respective parts in the exterior case for a hot water unit and the hot water unit according to the disclosure can be freely changed in various manners within an intended scope of the disclosure. Specific configurations of the respective processes in the method of manufacturing the exterior case for a hot water unit according to the disclosure can also be changed in various manners.

Although the example in which the stepped pressed portion and the ink-jet printing layer are provided only on the cover body has been described in the aforementioned embodiments, the disclosure is not limited thereto. In the disclosure, it is possible to employ a configuration in which the stepped pressed portion and the ink jet printing layer are also provided on the exterior case main body instead of or in addition to the cover body, for example. The number of combinations of stepped pressed portions and ink-jet printing layers is not limited to one, and a configuration in which a plurality of sets of stepped pressed portions and ink-jet printing layers are provided can also be employed.

The ink jet printing layer represents not only the letters of the manufacturer's logo, and any ink jet printing layer may be employed as long as the ink jet printing layer represents at least any of letters, symbols, figures, and patterns other than a logo. The stepped pressed portion can be formed into various forms and sizes.

The hot water unit according to the disclosure can also be formed as a hot water storing tank unit in which a hot water device for storing hot water is accommodated in an exterior case, such as a hot water storing tank, instead of a unit in which a hot water device for generating hot water is accommodated in an exterior case, such as a hot water dispenser. Therefore, the exterior case is also not limited to a combination of an exterior case main body with an opening front surface and a cover body that blocks the front surface opening portion.

Although the exterior case may be formed by using metal sheet parts, it is possible to use a metal sheet (for example, a stainless steel sheet with no paint layer, an aluminum sheet, or the like) that is different from a colored steel sheet) as a base material thereof.

What is claimed is:

1. An exterior case for a hot water unit, which is formed by using a metal sheet part and is used to accommodate a hot water device for generating or storing hot water therein, the exterior case, comprising:
a stepped pressed portion that is obtained by the metal sheet part being partially formed into a concave shape or a convex shape; and
coated films that are provided on a bottom surface or a top surface and a side wall surface of the stepped pressed portion,
wherein the coated films include an ink-jet printing layer provided at least on the bottom surface or the top surface of the stepped pressed portion, and the ink-jet printing layer represents at least any of letters, symbols, figures, and patterns.

2. The exterior case for a hot water unit according to claim 1, further comprising:
as the metal sheet part, an exterior case main body with at least one surface formed as an opening portion; and a cover body that is attached to the exterior case main body such that the cover body blocks the opening portion,
wherein the coated films including the stepped pressed portion and the ink-jet printing layer are provided on at least one of the exterior case main body and the cover body.

3. The exterior case for a hot water unit according to claim 1,
wherein the bottom surface or the top surface and the side wall surface of the stepped pressed portion have the coated films with different color hues.

4. The exterior case for a hot water unit according to claim 1,
wherein the coated films on the bottom surface or the top surface of the stepped pressed portion have a color hue that is different from a color hue of an outer surface of a circumferential portion of the stepped pressed portion.

5. The exterior case for a hot water unit according to claim 1, further comprising:
a transparent paint layer that covers the ink jet printing layer.

6. The exterior case for a hot water unit according to claim 1,
wherein as the stepped pressed portion, a stepped pressed portion that represents letters, symbols, figures, or patterns in a three-dimensional manner is provided.

7. A hot water unit comprising:
the exterior case for a hot water unit according to claim 1.

8. A method of manufacturing an exterior case for a hot water unit, which is formed by using a metal sheet part and is used to accommodate a hot water device for generating or storing hot water therein, the method comprising:
a painting process in which coated films including an ink-jet printing layer that represents at least any of letters, symbols, figures, and patterns are provided by performing ink-jet printing on outer surfaces of a substantially flat sheet-shaped metal sheet that is a base material of the metal sheet part; and
a pressing process in which a location in which the ink-jet printing layer is provided or the location and a surrounding portion thereof in the metal sheet are formed into a partially concave or convex stepped pressed portion, after the painting process.

9. The exterior case for a hot water unit according to claim 2,
wherein the bottom surface or the top surface and the side wall surface of the stepped pressed portion have the coated films with different color hues.

10. The exterior case for a hot water unit according to claim 2,
wherein the coated films on the bottom surface or the top surface of the stepped pressed portion have a color hue that is different from a color hue of an outer surface of a circumferential portion of the stepped pressed portion.

11. The exterior case for a hot water unit according to claim 3,
wherein the coated films on the bottom surface or the top surface of the stepped pressed portion have a color hue that is different from a color hue of an outer surface of a circumferential portion of the stepped pressed portion.

12. The exterior case for a hot water unit according to claim 2, further comprising:
a transparent paint layer that covers the ink-jet printing layer.

13. The exterior case for a hot water unit according to claim 3, further comprising:
a transparent paint layer that covers the ink jet printing layer.

14. The exterior case for a hot water unit according to claim 4, further comprising:
a transparent paint layer that covers the ink-jet printing layer.

15. The exterior case for a hot water unit according to claim 2,
wherein as the stepped pressed portion, a stepped pressed portion that represents letters, symbols, figures, or patterns in a three-dimensional manner is provided.

16. The exterior case for a hot water unit according to claim 3,
wherein as the stepped pressed portion, a stepped pressed portion that represents letters, symbols, figures, or patterns in a three-dimensional manner is provided.

17. The exterior case for a hot water unit according to claim 4,
wherein as the stepped pressed portion, a stepped pressed portion that represents letters, symbols, figures, or patterns in a three-dimensional manner is provided.

18. The exterior case for a hot water unit according to claim 5,
wherein as the stepped pressed portion, a stepped pressed portion that represents letters, symbols, figures, or patterns in a three-dimensional manner is provided.

19. A hot water unit comprising:
the exterior case for a hot water unit according to claim 2.

20. A hot water unit comprising:
the exterior case for a hot water unit according to claim 3.
